(19) United States
(12) Patent Application Publication
(10) Pub. No.: US 2014/0077508 A1
(43) Pub. Date: Mar. 20, 2014

(54) Steam Powered Turbine, Electric Power Regeneration System For A Vehicle

(71) Applicant: Brennan Mikael Prokopich, Laurel, NY (US)

(72) Inventor: Brennan Mikael Prokopich, Laurel, NY (US)

(21) Appl. No.: 13/622,626

(22) Filed: Sep. 19, 2012

(51) Int. Cl. H02K 7/18

(52) U.S. Cl. 290/1 R; 180/65.21; 903/904

(57) ABSTRACT

The present invention provides a steam powered turbine battery regeneration system for a vehicle hay an electrically operable drive system. The system includes at least one battery which is mounted within such vehicle and is connected to such drive system and at least one steam powered turbine which is mounted within such vehicle and is electrically coupled to the at least one battery. The steam powered turbine has a propeller fixed in a vertical plane and affixed to a horizontally disposed shaft mounted within such vehicle. A rotational movement of the propeller caused by a flow of steam enables the at least one turbine to generate an electric energy which is stored in the at least one battery which is used by such drive system to move such vehicle in a direction of travel.

### FIELD OF THE INVENTION

The present invention relates, in general, to a power regeneration system for vehicles and, more particularly, this invention relates to a steam power regeneration system for a vehicle which employs a steam operated turbine for generating electrical energy.

### BACKGROUND OF THE INVENTION

As is generally known, vehicles for private, commercial and military either run on petroleum or coal products or on a combination of petroleum products and electric energy. The electric energy is generally used only on land vehicles wherein it can be generated of by rotating wheels. Thus, undesirable vehicle emissions associated with the use of petroleum or coal products continue to be a worldwide problem.

Prior to the present invention, efforts have been made to eliminate use of petroleum or coal products. Over the years to this point, vehicles running on petroleum products or coal have left an overwhelmingly negative impression on earth with the emissions they leave behind. With the present invention you are able to reduce these emissions by nearly 99% by providing a means to regenerate electrical power to the power source of an electrically operable drive system or combination part electrically powered part combustion engine powered (hybrid) drive system. By being able to regenerate power to the vehicle via a steam power regeneration system you are able to reduce the cost of plugging in a battery powered drive system vehicle and further reducing costs of powering up batteries that provide the electric energy needed, thus providing the end consumer a very low cost way to travel.

### SUMMARY OF THE INVENTION

In a first aspect, the present invention provides a steam power regeneration system for a vehicle having an electrically operable or combination part electrically powered part combustion engine powered (hybrid) drive means. The steam power regeneration system for a vehicle includes at least one battery which is mounted within an interior portion of such vehicle and which is connected to such drive means. At least one steam powered turbine which is on or in the design of such vehicle and is electrically coupled to at least one battery. The at least one steam powered turbine has a propeller or combination of propellers fixed in a vertical plane mounted to a shaft having a horizontal plane and which is mounted within such vehicle.

A rotational movement of the propeller caused by a constant flow of steam from a heating source onto any element that will cause a steam, enables the at least one turbine to generate an electric energy through the at least one generator and then which is stored in the at least one battery and which is used by such drive means to move such vehicle in a direction of travel.

The present invention relates, in general, to a power regeneration system for vehicles and more particularly this invention relates to steam power regeneration system for a vehicle which employs a steam operated turbine for generating electrical energy.

In a further aspect, in combination with a vehicle having an electrically operable drive means or combination part electrically powered part combustion engine powered (hybrid) drive system with a steam power regeneration system. The steam power regeneration system includes at least one battery which is mounted within such vehicle and which is connected to such drive means. At least one steam powered turbine is mounted within such vehicle and is electrically coupled to at least one battery. The at least one steam powered turbine has at least one propeller which is fixed in a vertical plane along a horizontally disposed shaft which is mounted within such vehicle. A rotational movement of the at least one propeller caused by a constant flow of steam from a heating source onto any element that will cause a steam enables the at least one turbine to generate an electric energy which is stored in at least one battery and which is used by such drive means to move such vehicle in a direction of travel.

### OBJECTS OF THE INVENTION

It is therefore a primary object of the present invention to provide a power regeneration system for a vehicle that could operate solely on steam powered electric energy.

It is a further object of the present invention to vastly reduce the operating costs that are typically associated with the use of an internal combustion engine by eliminating the need for expensive petroleum fuels.

It is a further object of the present invention to almost eliminate fuel emissions that are associated with the use of the internal combustion engine.

It is a further object of the present invention to provide a steam power regeneration system which can store excess generated electric energy that can be utilized by returning the power to the national electric grid.

It is a further object of the present invention to provide a steam power regeneration system which is easy to manufacture.

### BRIEF DESCRIPTION OF THE DRAWINGS

FIG. 1 is a block diagram of the steam power regeneration system of the present invention.

FIG. 2 is a schematic representation of steam power regeneration system of the present invention.

FIG. 3 is a schematic representation of a steam power regeneration system of the present invention shown with the use of a plurality of components.

FIG. 4 is a schematic representation of a steam power regeneration system of the present invention shown in use on a passenger automobile.

FIG. 5 is a schematic representation of a steam power regeneration system of the present invention shown in use on an airplane.

FIG. 6 is a schematic representation of a steam power regeneration system of the present invention shown in use on a semi tractor trailer.

FIG. 7 is a schematic representation of a steam power regeneration system of the present invention shown in use on a train.

FIG. 8 is a schematic representation of a steam power regeneration system of the present invention shown in use on a watercraft.

FIG. 9 is a schematic representation of a steam power regeneration system of the present invention shown in use on a motorcycle.

### BRIEF DESCRIPTION

To make this description more clear, identical components having identical functions have been assigned with reference numerals.

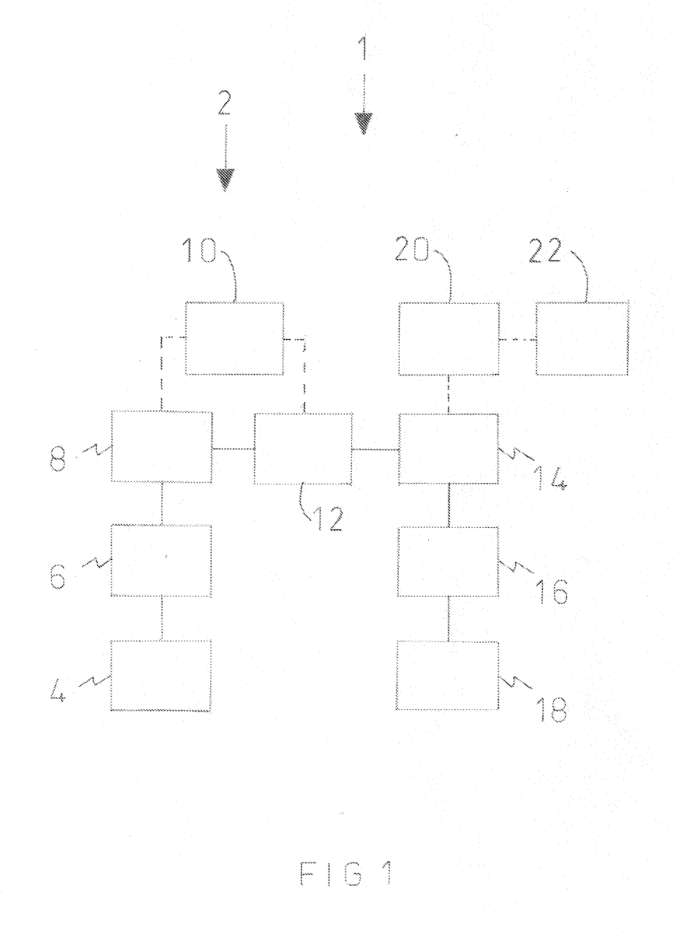

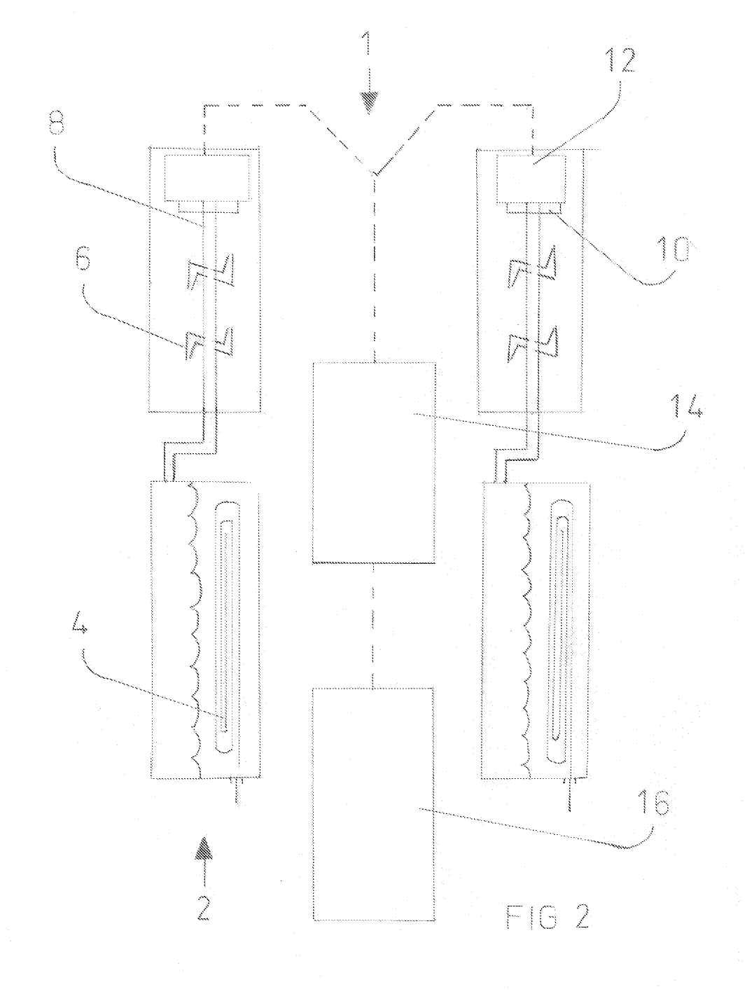

Refer to FIGS. 1-9 of the drawings illustrated therein is a steam power regeneration system which is designated #1 which is usable on a vehicle. The system designated #1 includes a steam generated turbine designated #2. Briefly the turbine includes at least one propeller designated #6 formed from a plurality of spouts, a rotor shaft designated #8, and mounted stabilizers for the rotor shaft designated #26. Attached at the end of at least one rotor shaft is a gear system designated #10 which may or may not be attached at the end of at least one rotor shaft mounted to the vehicle.

As it is known in the art, a steam current caused by a heating source designated #4 onto any element that will cause a steam enables the rotation of the at least one propeller #6 and subsequently causes a rotation of the rotor shaft #8 which enables the gear system #10 to generate electric energy through a generator #12 positioned at the end of the at least one rotor shaft #8.

The turbine #2 is electrically coupled to the at least one battery #14 positioned within the vehicle. As it is known in the art, such at least one battery #14 is capable of storing electric energy generated by the steam power regeneration system #1. The at least one battery #14 is in turn electrically coupled to a propulsion drive system #18. Such propulsion drive system #18 employs an electric motor designated #16 which uses the generated or stored electric energy to move the vehicle in a direction of travel. The electric motor #16 is positioned adjacent to the final phase of the vehicles drive system designated #18.

It has been found advantageous to mount the steam power regeneration system #1 in the vehicle, then affixing the rotor shaft #8 with the attached propeller #6 into the gear system #10 and generator #12 through the tunnel #24. In such an arrangement due to the constant flow of steam, one or more propellers #6 producing the rotation of the rotor shaft #8 and then enabling generation of the electric energy from the generator #12. The air current is then directed into the tunnel #24 and from there out of the vehicle through a vent.

The generated electric energy is stored within the at least one battery #14 and then is drawn by the electric motor #16 and then onto the final phase of the drive system #18. It can be appreciated that a plurality of batteries #14 electrically coupled there between into a battery storage system enables storing the excess electric energy which then can be drawn by the electric motor #16 when needed.

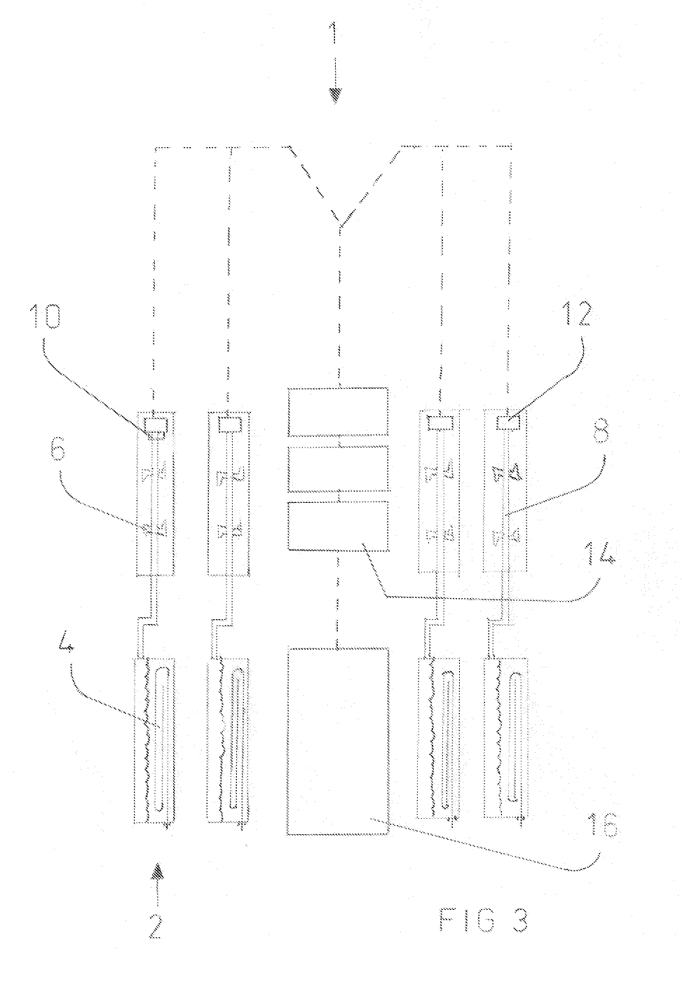

Furthermore, a plurality of steam power regeneration systems #1, and a plurality of rotor shafts #8, and a plurality of generators #12 may be employed in the present invention as shown in FIG. 3 to generate a pre-determined amount of electric energy.

The steam power regeneration system #1 may include an inverter #20 means for connecting the at least one battery #14 to an electric grid #22 to return any excess power back to the national system.

In the present invention, the term vehicle is generally directed to any land, water or air type vehicle including but not limited to a passenger automobile, cargo transport vehicle, military vehicle, recreational vehicle, watercraft, motorcycle, cycle, mobile cart, wheelchair, aircraft, or locomotive.

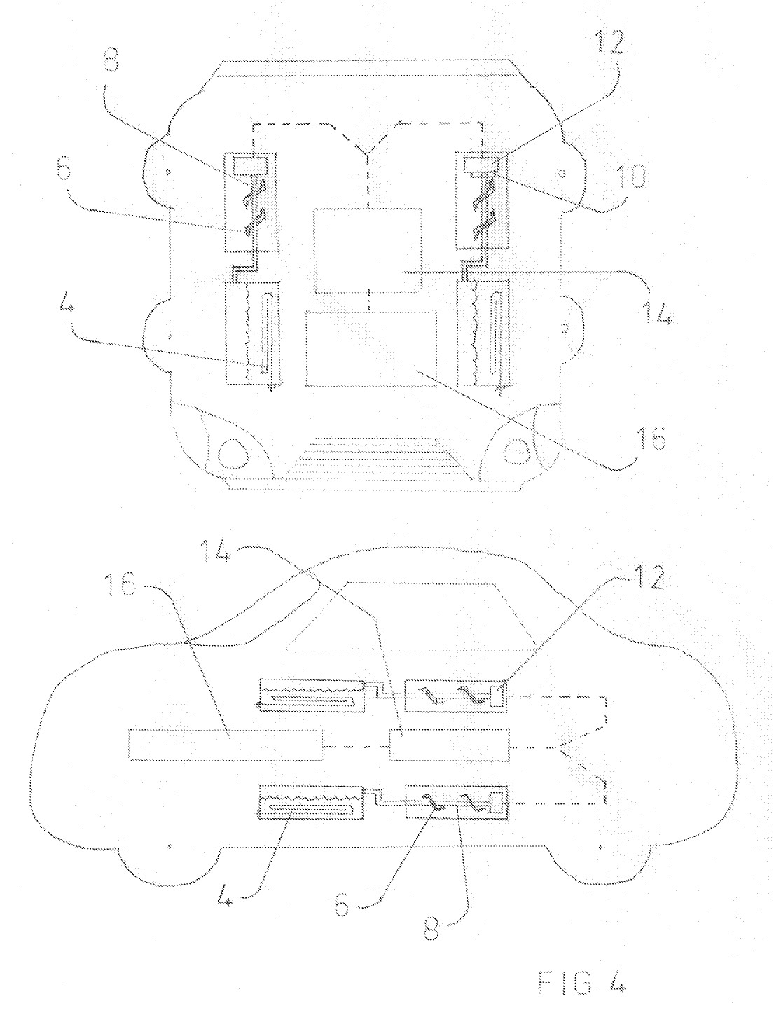

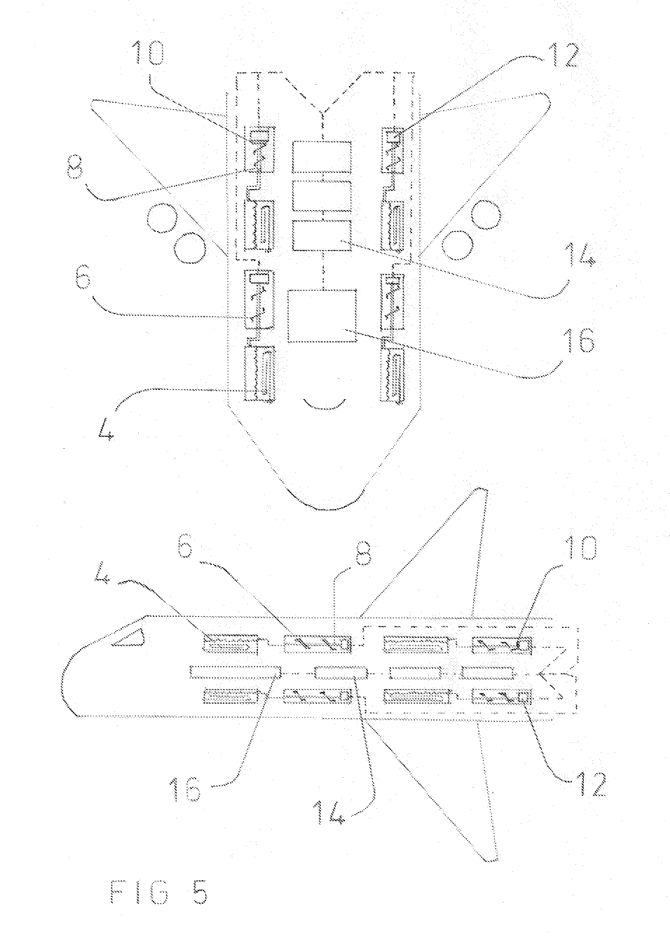

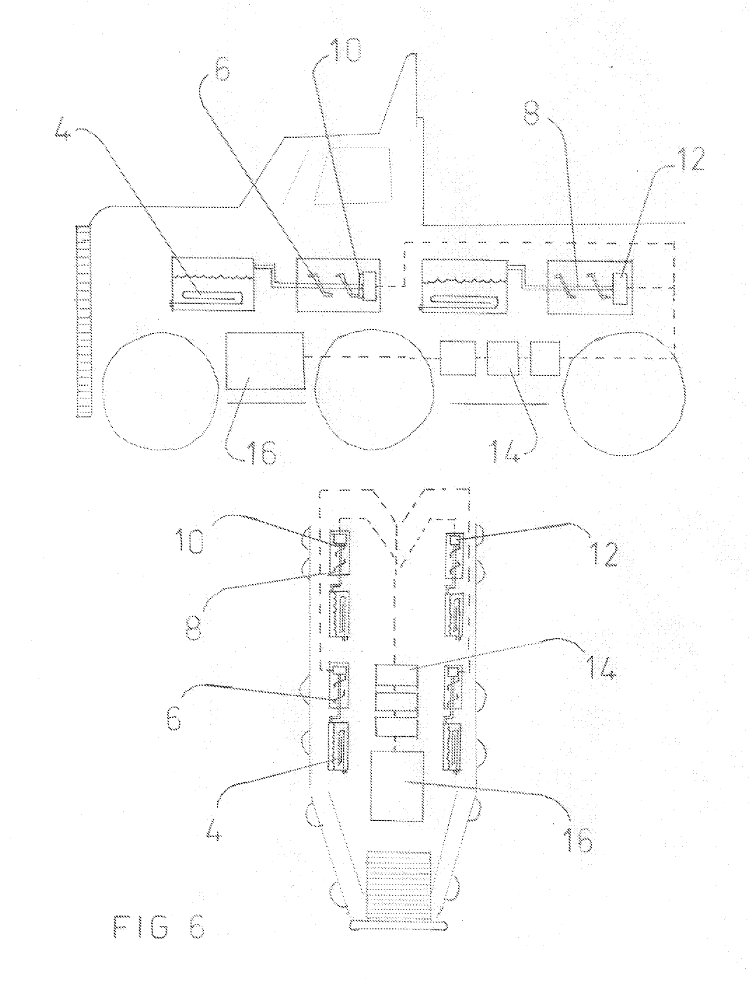

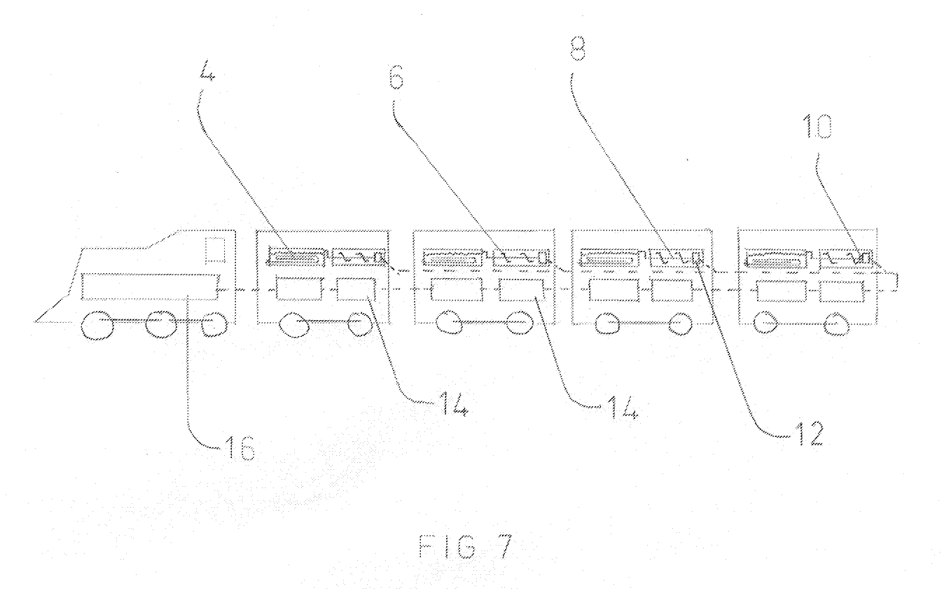

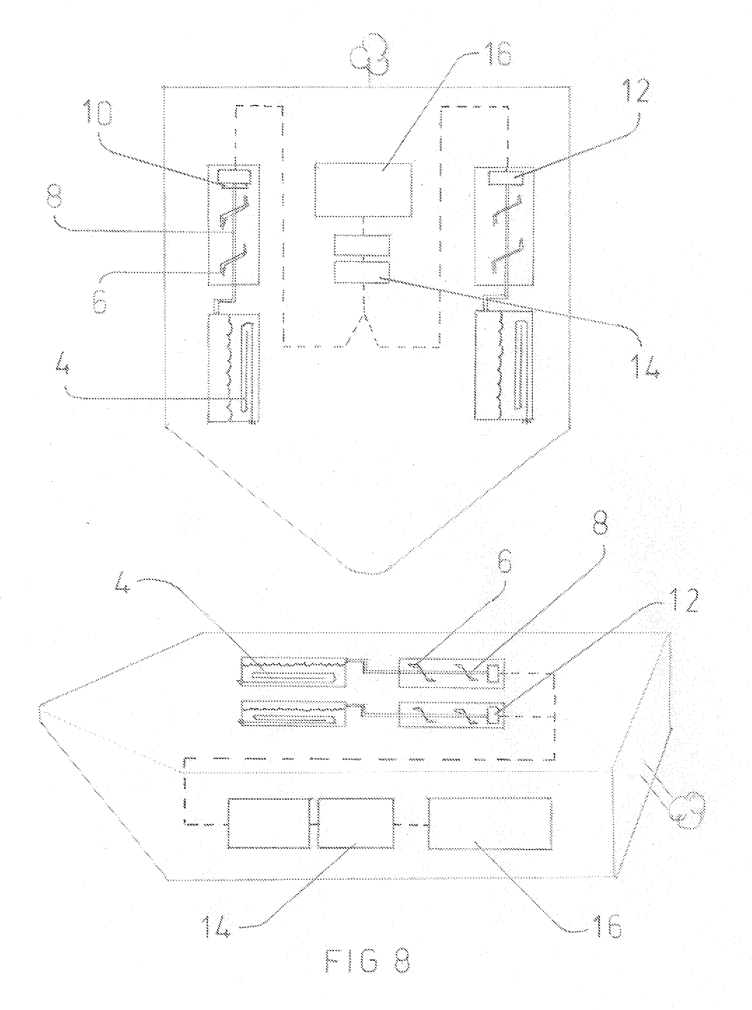

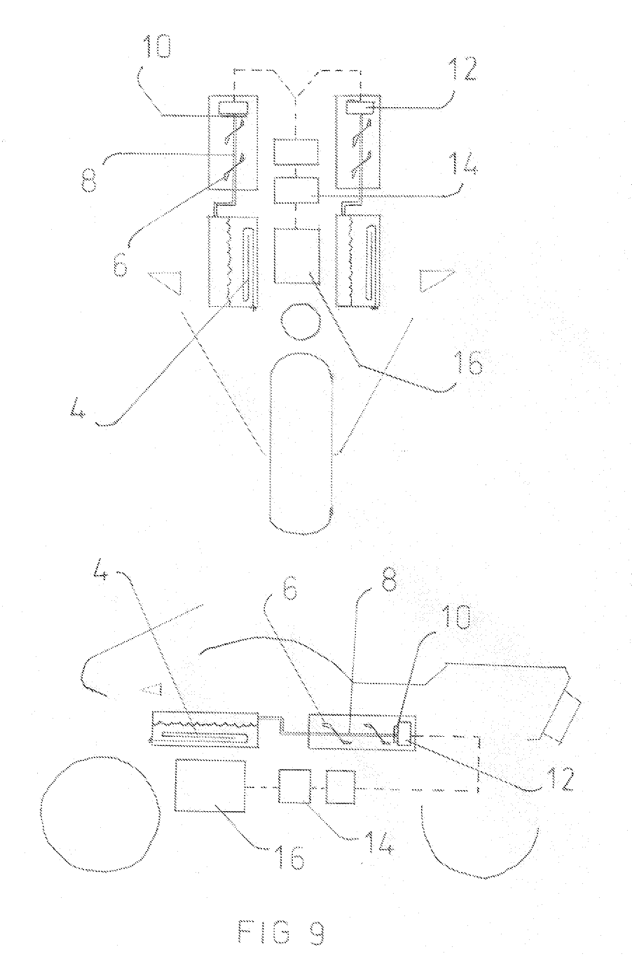

For example FIG. 4 illustrates the use of the steam power regeneration system of the present invention on a passenger automobile. FIG. 5 illustrates the use of the steam power regeneration system of the present invention on an airplane. FIG. 6 illustrates the use of the steam power regeneration system of the present invention on a cargo transport vehicle. FIG. 7 illustrates the use of the steam power regeneration system of the present invention on a locomotive, train. FIG. 8 illustrates the use of the steam power regeneration system of the present invention on a watercraft. FIG. 9 illustrates the use of the steam power regeneration system of the present invention on a motorcycle.

Thus, the present invention has been described in full, clear, concise and exact terms as to enable a person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the claims.

I claim:

1. A steam powered system comprising
1. An electric motor, or combination electric and internal combustion (Hybrid) motor adjacent one of a rear or front portion and a final drive system of a vehicle.
2. At least one battery mounted within said vehicle and connected to said electric motor, or combination electric and internal combustion (Hybrid) motor, and
3. At least one steam powered turbine mounted within such vehicle and coupled to said at least one battery for generating an electric energy which is stored in said at least one battery and used by said electric motor, or combination electric and internal combustion (Hybrid) motor to move such vehicle in a direction of travel; wherein said steam powered turbine includes the at least one propeller fixed in a vertical plane and affixed to a horizontally disposed shall running on a longitudinal axis down or through a tunnel all mounted within such vehicle.
